(19) United States
(12) Patent Application Publication
(10) Pub. No.: US 2017/0287586 A1
(43) Pub. Date: Oct. 5, 2017

(54) Electroconductive Resin Composite and Electroconductive Resin Composition Having Excellent Impact Strength, and Method of Producing the Same

(71) Applicants: SK Innovation Co., Ltd., Seoul (KR); SK Global Chemical Co., Ltd., Seoul (KR)

(72) Inventor: Yun Kyun Lee, Daejeon (KR)

(21) Appl. No.: 15/471,674

(22) Filed: Mar. 28, 2017

(30) Foreign Application Priority Data
Mar. 29, 2016 (KR) 10-2016-0037770
Dec. 14, 2016 (KR) 10-2016-0170562

(51) Int. Cl. H01B 1/20; C08J 3/22; C08L 77/06

(52) U.S. Cl. CPC H01B 1/20; C08L 77/06; C08J 3/22; C08L 2203/20; C08J 2377/06; C08J 2423/20

(57) ABSTRACT

An electroconductive resin composite having excellent impact strength, in which an impact modifier and an electroconductive filler are dispersed in a matrix resin, is provided. The impact modifier has an average particle size of 5 μm or less and is dispersed in a domain form in a polyamide matrix resin, and the number of agglomerates of the filler in which a longest diameter of an agglomerate particle is 10 μm or more is 50 or less, in 50 scanning electron microscope (SEM) images of an area of 0.5 mm×0.35 mm, captured at 250× magnification.

### CROSS-REFERENCE TO RELATED APPLICATIONS

This application claims priority to Korean Patent Application No. 10-2016-0037770 filed Mar. 29, 2016, and Korean Patent Application No. 10-2016-0170562 filed Dec. 14, 2016, the disclosures of which are hereby incorporated in their entirety by reference.

### BACKGROUND OF THE INVENTION

### 1. Field of the Invention

The present disclosure relates to an electroconductive resin composite, an electroconductive resin composition, and a method of producing the same, and more particularly, to an electroconductive resin composite and an electroconductive resin composition having improved impact strength, and a method of producing the same.

### 2. Description of Related Art

In general, polymers may provide various physical properties via molecular designs and have excellent processability, mechanical strength, electrical insulation, optical transparency, mass productivity, and the like, as compared with other materials. Further, polymers have been used as important novel materials in high-tech industry, for example, the semiconductor industry, the electric industry, the electronics industries, the aerospace industry, and the defense industry, as well as in displays, alternative energy sources, and the like. However, such a polymer material may have low thermal and mechanical properties as compared with an inorganic material, and thus, physical properties thereof are required to be improved for the application thereof as a new material.

In this regard, when a polymer material is to be used in an art requiring electrical conductivity, an electroconductive filler has been added to a polymer material to provide sufficient conductivity to the polymer material, as well as to improve physical properties thereof. In this case, a carbonaceous material such as carbon nanotubes (CNT), graphite, or the like has been used as an electroconductive filler added for imparting electrical conductivity.

On the other hand, when an additive is used in order to improve such conductivity or mechanical physical properties, the additive may act as an impurity in a resin composition, resulting in a problem in which impact strength of a polymer material generally decreases. In order to improve such impact strength, an impact modifier is added to a resin composition.

In order to produce a resin composite including an impact modifier and an electroconductive filler in the related art, or as a resin composition for production of such a polymer composite, an electroconductive masterbatch has been produced by melt-mixing a matrix polymer resin, an electroconductive filler, and an impact modifier.

### SUMMARY OF THE INVENTION

An aspect of the present disclosure is to provide a resin composite in which impact resistance and conductivity may be improved as an impact modifier is precisely and evenly dispersed and an electroconductive filler forms a network in a resin composition including an impact modifier and an electroconductive filler in a matrix resin.

According to an aspect of the present disclosure, an electroconductive resin composite having excellent impact strength includes a polyamide resin matrix, impact modifier domains dispersed in the matrix, the domains having an average particle size of 5 μm or less (excluding 0) and electroconductive fillers dispersed in the matrix, wherein the number of agglomerates of the fillers in which the length of a longest diameter of an agglomerate is 10 μm or more is 50 or less, in 50 scanning electron microscope (SEM) images of an area of 0.5 mm×0.35 mm, captured at 250× magnification.

90% or more of a total weight of the fillers is present in the polyamide matrix resin or at an interface between the polyamide matrix resin and the impact modifier.

A level of interfacial energy between the impact modifier and the fillers is higher than a level of interfacial energy between the polyamide matrix resin and the filler.

The composite may include 1 wt % to 40 wt % of the impact modifier and 0.1 wt % to 20 wt % of the fillers based on the total weight of the composite.

The composite further includes a compatibilizing agent.

The compatibilizing agent is a graft copolymer grafted from maleic anhydride (MAH) or glycidyl methacrylate (GMA).

The composite includes 1 wt % to 40 wt % of the impact modifier, 0.5 wt % to 10 wt % of the compatibilizing agent and 0.1 wt % to 20 wt % of the fillers based on the total weight of the composite.

The domains include at least one selected from the group consisting of a polyolefin elastomer, a polystyrene elastomer, thermoplastic polyurethane, a polyester polymer, a vinyl chloride resin, and an acrylic copolymer.

The domains include polyolefin elastomer.

The polyolefin elastomer is copolymer of ethylene and octene or copolymer of ethylene and butane.

The fillers are at least one carbon material selected from the group consisting of a carbon nanotube, carbon black, graphite, graphene, and carbon fiber.

According to an aspect of the present disclosure, an electroconductive resin composition having excellent impact strength includes a polyamide resin and a masterbatch including an impact modifier and electroconductive fillers, wherein, with respect to the electroconductive fillers, interfacial energy of the impact modifier is higher than interfacial energy of the polyamide resin.

The masterbatch is included in an amount of 0.1 wt % to 50 wt % based on the total weight of the composition, and wherein the masterbatch includes 1 wt % to 50 wt % of the fillers based on the total weight of the masterbatch.

The composition may further include a compatibilizing agent.

The composition includes 0.5 wt % to 10 wt % of the compatibilizing agent and 0.1 wt % to 50 wt % of the masterbatch based on the total weight of the composition, and wherein the masterbatch includes 1 wt % to 50 wt % of the fillers based on the total weight of the masterbatch.

The masterbatch further includes a compatibilizing agent.

In this case, the masterbatch is included in an amount of 0.1 wt % to 50 wt % based on the total weight of the composition, wherein the masterbatch includes 1 wt % to 50 wt % of the fillers and 0.5 wt % to 10 wt % of the compatibilizing agent based on the total weight of the masterbatch.

The impact modifier is at least one selected from the group consisting of a polyolefin elastomer, a polystyrene elastomer, thermoplastic polyurethane, a polyester polymer, a vinyl chloride resin and an acrylic copolymer.

The polyolefin elastomer is copolymer of ethylene and octene or copolymer of ethylene and butane.

The electroconductive filler is at least one carbon material selected from the group consisting of a carbon nanotube, carbon black, graphite, graphene, and carbon fiber.

The compatibilizing agent is a graft copolymer grafted from maleic anhydride (MAH) or glycidyl methacrylate (GMA).

According to an aspect of the present disclosure, a method of producing an electroconductive resin composite having excellent impact strength includes mixing a materbatch including an impact modifier and electroconductive filler with a polyamide resin to prepare a electroconductive resin composition and melt molding the composition to prepare a composite including: a resin matrix including the polyamide resin; impact modifier domains including the impact modifier, the domains being dispersed in the matrix and having an average particle size of 5 μm or less; and electroconductive fillers dispersed in the matrix, wherein the number of agglomerates of the fillers in which the length of a longest diameter of an agglomerate is 10 μm or more is 50 or less, in 50 scanning electron microscope (SEM) images of an area of 0.5 mm×0.35 mm, captured at 250× magnification.

The method further comprises melt-mixing the impact modifier and the fillers to prepare the masterbatch.

The method further comprises melt-mixing the impact modifier, the fillers and a polyamide resin to prepare a secondary masterbatch.

The composition further comprises a compatibilizing agent.

The masterbatch further includes a compatibilizing agent.

The secondary masterbatch further includes a compatibilizing agent.

The compatibilizing agent is a copolymer grafted from maleic anhydride (MAH) or glycidyl methacrylate (GMA).

### BRIEF DESCRIPTION OF DRAWINGS

The above and other aspects, features and other advantages of the present disclosure will be more clearly understood from the following detailed description taken in conjunction with the accompanying drawings, in which:

FIG. 1A illustrates dispersion of CNTs in a polymer primarily present in the form of a domain in a polymer composite including two types of heterogeneous polymer;

FIG. 1B illustrates dispersion of carbon nanotubes (CNTs) in a polymer primarily present in the form of a matrix in a polymer composite including two types of heterogeneous polymer;

FIG. 1C illustrates dispersion of CNTs present at an interface between a matrix polymer and a domain polymer in a polymer composite including two types of heterogeneous polymer;

FIG. 2 is a diagram illustrating factors for a contact angle measurement method for interfacial energy measurement;

FIG. 3 is a diagram conceptually illustrating a transition phenomenon according to affinity of an electroconductive filler with a polymer according to an exemplary embodiment in the present disclosure;

FIGS. 4A and 4B are images obtained by capturing an image of a surface of a resin composite molded article obtained in Embodiment 1 using a scanning electron microscope (SEM), wherein FIG. 4A is a SEM image at a magnification of 250× and FIG. 4B is a SEM image at a magnification of 15,000×;

FIG. 5 is an SEM image illustrating a surface of a resin composite molded article obtained in Embodiment 2;

FIGS. 6A and 6B are SEM images illustrating a surface of a resin composite molded article obtained in Embodiment 3, wherein FIG. 6A is an SEM image at a magnification of 250×, and FIG. 6B is an SEM image at a magnification of 20,000×;

FIG. 7 is an SEM image obtained by capturing an image of a surface of a resin composite molded article obtained in Comparative Example 2;

FIG. 8 is an SEM image illustrating a surface of a resin composite molded article obtained in Embodiment 3;

FIG. 9 is an SEM image illustrating a surface of a resin composite molded article obtained in Embodiment 4;

FIGS. 10A and 10B are SEM images illustrating a surface of a resin composite molded article obtained in Comparative Example 6, wherein FIG. 10A is an SEM image at a magnification of 250×, and FIG. 10B is an SEM image at a magnification of 20,000×; and

FIGS. 11A and 11B are SEM images illustrating a surface of a resin composite molded article obtained in Comparative Example 7, wherein FIG. 11A is an SEM image at a magnification of 250×, and FIG. 11B is an SEM image at a magnification of 20,000×.

### DETAILED DESCRIPTION OF THE INVENTION

Hereinafter, embodiments of the present disclosure will be described with reference to the accompanying drawings.

The present disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

Throughout the specification, it will be understood that when an element, such as a layer, region or wafer (substrate), is referred to as being “on,” “connected to,” or “coupled to” another element, it can be directly “on,” “connected to,” or “coupled to” the other element or other elements intervening therebetween may be present. In contrast, when an element is referred to as being “directly on,” “directly connected to,” or “directly coupled to” another element, there may be no elements or layers intervening therebetween. Like numerals refer to like elements throughout. As used herein, the term “and/or” includes any and all combinations of one or more of the associated listed items.

It will be apparent that though the terms first, second, third, etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below may be termed a second member, component, region, layer or section without departing from the teachings of the embodiments.

Spatially relative terms, such as “above,” “upper,” “below,” and “lower” and the like, may be used herein for ease of description to describe one element's relationship to another element(s) as shown in the figures. It will be understood that the spatially relative terms are intended to encompass different orientations of the device in use or operation in addition to the orientation depicted in the figures. For example, if the device in the figures is turned over, elements described as “above,” or “upper” other elements would then be oriented “below,” or “lower” the other elements or features. Thus, the term “above” can encompass both the above and below orientations depending on a particular direction of the figures.

The terminology used herein describes particular embodiments only, and the present disclosure is not limited thereby. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

According to exemplary embodiments in the present disclosure, a method of obtaining a resin composite having excellent impact resistance, while including an electroconductive filler to provide electrical conductivity, a resin composite obtained thereby, and a resin composition therefor are provided.

An electroconductive filler is generally added to a resin in order to impart electrical conductivity to a polymer material, but in this case, impact resistance may be significantly deteriorated due to the added electroconductive filler. Thus, an impact modifier may be added in order to suppress deterioration of impact resistance.

Electroconductive polymer composites in the related art have been produced by directly blending and melt-mixing a matrix resin, an impact modifier and an electroconductive filler. However, in the case in which such an impact modifier is merely added in order to impart impact resistance characteristics, the size of particles of an impact modifier present as domains in a matrix resin may not be uniform and dispersion thereof may be uneven. Thus, the electrical physical properties and impact resistance effects of a resin composite may not be sufficiently exhibited.

For example, in the related art, it is only intended to improve dispersibility by adjusting a content of an impact modifier added to improve impact resistance of an electroconductive resin composite or by adding other additives. In this case, effects of morphology of an impact modifier in a polymer composite, a disposition form of an electroconductive filler, and the like on electrical conductivity and impact resistance are not recognized.

However, according to an exemplary embodiment in the present disclosure, an electroconductive filler and an impact modifier may have specific morphologies in a polyamide matrix to increase electrical conductivity and impact resistance. According to results of research by the present inventors, such morphology may be obtained by blending and melt-mixing a polyamide matrix resin, an impact modifier, and an electroconductive filler using a specific method, as illustrated in exemplary embodiments of the present disclosure as below.

In the case of a resin composite provided according to an exemplary embodiment in the present disclosure, an impact modifier and an electroconductive filler may be dispersed in a polyamide matrix resin.

In the polymer composite, the polyamide matrix resin may be a main component of a polymer composite, and thus, the polyamide resin may be applied to exemplary embodiments in the present disclosure without particular limitations as long as it is a polyamide resin. As the polyamide resin, for example, PA66, PA6, PA12, or the like may be used.

Although the impact modifier is not particularly limited, a material may be suitably applied to exemplary embodiments as long as it has properties similar to those of rubber and may perform an impact resistance function for other resins. As the impact modifier having rubber properties, a thermoplastic elastomer (TPE) may be used. Although it is not particularly limited, examples of the impact modifier may include a polyolefin elastomer (POE), at least one selected from the group consisting of high density polyethylene (HDPE), low density polyethylene (LDPE), linear low density polyethylene (LLDPE), an ethylene-α-olefin copolymer such as ethylene octene rubber (EOR), ethylene butene rubber (EBR) and the like, modified high-density polyethylene, modified low-density polyethylene, modified linear low-density polyethylene and a modified ethylene-α-olefin copolymer modified with a compound selected from the group consisting of α,β-unsaturated dicarboxylic acids and α,β-unsaturated dicarboxylic acid derivatives; at least one polystyrene elastomer selected from the group consisting of a block copolymer comprised of an aromatic vinyl compound and a conjugated diene compound, a hydrogenated block copolymer obtained by hydrogenating a block copolymer comprised of an aromatic vinyl compound and a conjugated diene compound, a modified block copolymer obtained by modifying the block copolymer with a compound selected from the group of α,β-unsaturated dicarboxylic acids and α,β-unsaturated dicarboxylic acid derivatives, and a modified hydrogenated block copolymer obtained by modifying the hydrogenated block copolymer with a compound selected from the group of α,β-unsaturated dicarboxylic acids and α,β-unsaturated dicarboxylic acid derivatives; a thermoplastic styrenic block copolymer (TPS) such as styrene-ethylene-butadiene-styrene (SEBS), styrene-butadiene-styrene (SBS), styrene-ethylene-propylene-styrene (SEPS), or SEPS-V; thermoplastic polyurethane (TPU); a thermoplastic polyester-based polymer (TPEE); a vinyl chloride resin; an acrylic copolymer such as ethylene ethyl acrylate (EEA), ethylene methacrylate (EMA) or the like; thermoplastic polyamide (TPAE); and the like.

In detail, the polyolefin elastomer (POE) may be more usefully used. For example, the POE having a density of 0.857 to 0.885 g/cm³ and a melting index (MI) of 0.5 to 30 g/10 min (190° C., 2.16 kg) may be used.

On the other hand, a resin composite according to an exemplary embodiment in the present disclosure may further include a compatibilizing agent. The compatibilizing agent may bean additive to improve miscibility of an impact modifier and a polyamide matrix resin, and may further increase an impact strength improving effect of the polyamide matrix resin. In addition, as the compatibilizing agent is included, electroconductive fillers such as CNTs or the like may be dispersed to an interface between a polyamide matrix resin and an impact modifier such as POE or the like, thereby facilitating formation of a network structure of the electroconductive filler.

The compatibilizing agent may be used together with an impact modifier and electroconductive fillers such as CNTs or the like, to thus form a masterbatch, and may also be used separately from a masterbatch formed by an impact modifier and electroconductive fillers. The compatibilizing agent is dispersed in the matrix and/or in the domains and/or at an interface between the matrix and the domains.

The compatibilizing agent may be a block copolymer or a graft copolymer, and may be a copolymer grafted from at least one selected from the group consisting of maleic anhydride (MAH) and glycidyl methacrylate (GMA). In detail, a graft copolymer grafted from MAH or GMA may be used in a compound suitable as an impact modifier in an exemplary embodiment.

Further, the electroconductive filler may be an additive providing electrical conductivity of a molded polymer article. Although the electroconductive filler is not particularly limited as long as it is generally used, a carbonaceous material may be used in an exemplary embodiment. Examples of such carbonaceous materials may include a carbon nanotube (CNT), carbon black, graphite, graphene, carbon fiber, and the like. Any one thereof may be used alone, or two or more thereof may be used in combination. In further detail, a carbon nanotube may be used.

The impact modifier may be added to compensate for reduced impact resistance due to a electroconductive filler included in a polyamide matrix resin. According to an exemplary embodiment in the present disclosure, the impact modifier may be present in the form of a domain in the polyamide matrix resin, may be present in a particle state, and may be dispersed in a state in which the domain particles are separated from each other in a state of severance.

In the case of the impact modifier present in the polyamide matrix resin while forming a domain therein, as the size of a domain shape is reduced in the polyamide matrix resin and domain particles are evenly dispersed, impact resistance of the polyamide matrix resin may be improved.

A domain of the impact modifier may be present in a matrix resin at an average particle diameter of 5 μm or less (excluding ‘0’), in detail, 3 μm or less (excluding ‘0’). As the impact modifier is evenly dispersed in the resin composite in a domain form of small particles, impact resistance of the resin composite may be improved. The size of the domain may be, for example, within a range of 1 μm to 5 μm, in detail, may have an average particle size of 1 μm to 3 μm or 1 μm to 1.5 μm.

Although the size of the domain may be measured by various methods, in the case of an exemplary embodiment in the present disclosure, five Izod Impact specimens (ASTM D256) were broken in liquid nitrogen, and then, with respect to the broken specimens, 10 SEM images of each specimen were randomly obtained via capturing thereof using a SEM at 5K× magnification. Values calculated by averaging domain sizes for all 50 images were used.

In this case, it does not mean that domain particles having a particle size larger than 5 μm in the resin composite should not be completely present, and thus, the domain particles may be partially present in the form of particles larger than 5 μm. However, a domain having such a large particle size larger than 5 μm should be limited to 10 wt % or less of a total domain, and a domain having a particle size greater than 5 μm may be required to be reduced as much as possible, and thus, for example, may be provided in an amount of 5 wt % or less, 3 wt % or less, 1 wt % or less, or 0.5 wt % or less, and in further detail, may not be present.

If the domain having a particle size exceeding 5 μm is present in an amount of 10 wt % or more, a problem, in which mechanical strength significantly decreases as a result that compatibility between a polyamide matrix resin and an impact modifier in a resin composite is poor, may occur.

Furthermore, in the case of the domain size, a standard deviation thereof may be required to be further reduced, and for example, the standard deviation may be 5 μm or less, 3 μm or less, 2 μm or less, or 1 μm or less, and may also be 0 μm.

A polyamide matrix resin and an impact modifier provided as a resin constituting a resin composite provided in an exemplary embodiment may have different affinities to electroconductive fillers. Further, the affinity of the matrix resin to the electroconductive fillers may be greater than that of the impact modifier thereto.

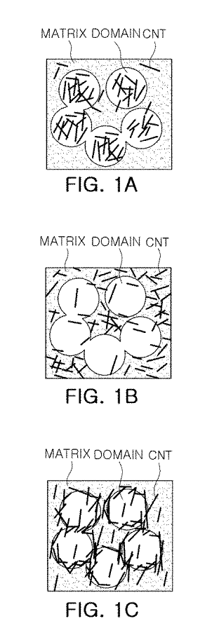

FIG. 1 conceptually illustrates a state in which electroconductive fillers are present in a composite including a polyamide matrix resin and an impact modifier. When the electroconductive fillers are uniformly dispersed in the polyamide matrix to form a network, excellent electrical conductivity may be provided. However, as illustrated in FIG. 1A, the impact modifier is present in the polyamide matrix resin while forming a domain therein, and for example, if the electroconductive fillers are mainly present in the domain of the impact modifier, the electroconductive fillers may not form a network such that electrical conductivity may not be properly exhibited.

On the other hand, when the affinity of the polyamide matrix resin to the electroconductive filler is greater than that of the impact modifier thereto, as illustrated in FIG. 1B, the electroconductive fillers may be mainly located in the matrix resin having relatively high affinity thereto, or as illustrated in FIG. 1C, the electroconductive fillers may be located at an interface between the matrix resin and domains of the impact modifier. When the electroconductive fillers is present in such a form, the electroconductive fillers may form a network to thus exhibit excellent electrical conductivity.

Thus, according to an exemplary embodiment in the present disclosure, the affinity of the polyamide matrix resin to the electroconductive filler may be higher than that of the impact modifier thereto. The affinity as above may be represented by interfacial energy of the matrix resin and the impact modifier to the electroconductive fillers, and as the interfacial energy is increased, the affinity may be lowered.

Interfacial energy of a substance may be determined by a sum of forces of different atoms or molecules on a surface, and may be divided into a polar component and a nonpolar component, dispersion. The interfacial energy may be measured via a contact angle measurement method using the following equation. In this case, two solutions of deionized (DI) water and diiodomethane may be used.

$$\frac{{γ}_{l} ( 1 + cos θ )}{2 \sqrt{{γ}_{l}^{d}}} = \sqrt{{γ}_{s}^{p}} ( \frac{\sqrt{{γ}_{l}^{p}}}{\sqrt{{γ}_{l}^{d}}} ) + \sqrt{{γ}_{s}^{d}} . \\ {γ}_{d} = {γ}_{s} + {γ}_{l} - 2 {( {γ}_{l}^{d} {γ}_{s}^{d} )}^{1 / 2} - 2 {( {γ}_{l}^{p} {γ}_{s}^{p} )}^{1 / 2}$$

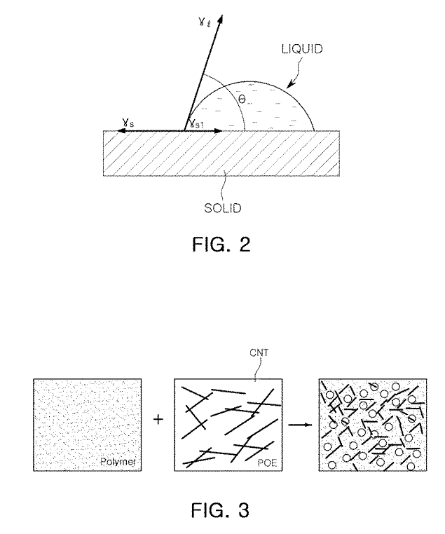

In the equation above, γₛ=γₗ·cos θ+γₛₗ (Young equation), where θ refers to a contact angle, γₛ refers to solid surface free energy, γₗ refers to liquid surface free energy, and γₛₗ refers to solid/liquid interfacial free energy, between which schematic relationships are illustrated in FIG. 2.

In the equation above, p represents a polarity, and d represents dispersion.

In the exemplary embodiment, the presence of the electroconductive fillers at an interface with the polyamide matrix indicates that electroconductive fillers are present over a domain and a polyamide matrix in terms of a single electroconductive filler as illustrated in FIG. 1C. For example, a portion of an electroconductive filler may be present in the polyamide matrix while a remaining portion thereof is present in the domain.

On the other hand, in the case of the impact modifier domain, an interval between adjacent domains in the polyamide matrix resin may be changed depending on a content of the impact modifier with respect to the polyamide matrix resin, and may not be always constant, and thus, is not particularly limited. For example, when the content of the impact modifier forming the domain is relatively low, an interval between the domains may be increased, and when a domain size is relatively small, an interval between the domains may be reduced. For example, when an interval between domains is represented as an average value, the interval may be 10 μm or less, in detail, in a range of 2 μm or more to 5 μm or less. For example, when a domain size is relatively small and an interval between domains is relatively narrow, it may be determined that the domains are uniformly dispersed in a composite, and thus, impact resistance may be increased.

Meanwhile, in an exemplary embodiment of the present disclosure, the electroconductive filler may be present in the polyamide matrix or may be present at an interface between the polyamide matrix and the impact modifier. As described above, the electroconductive fillers may forma network to thus provide excellent electrical conductivity of a polymer composite. Thus, the electroconductives filler may be present in the polyamide matrix to form a network, or may be present at an interface between the polyamide matrix and the impact modifier to form a network.

In terms of obtaining good conductivity even with a relatively small amount of electroconductive fillers, most of electroconductive fillers may be present in a polyamide matrix or at an interface, but it does not indicate that all of the electroconductive fillers should not be present in domains of an impact modifier. For example, 10 wt % or less of carbon nanotube may be present in the impact modifier.

The resin composite according to an exemplary embodiment may be produced using behavior characteristics of the electroconductive filler, based on affinity of the polyamide matrix resin and the impact modifier to the electroconductive filler.

As described above, in an exemplary embodiment, a polyamide polymer having relatively high affinity to the electroconductive filler may be used as the matrix resin, and a polymer having relatively low affinity thereto as compared with the polyamide matrix resin may be used as the impact modifier. In this case, when a resin composite is produced by blending and melt-mixing the above three components, for example, the polyamide matrix resin, the impact modifier, and the electroconductive fillers, the electroconductive fillers may be present at an interface or in the polyamide matrix resin having relatively high affinity.

However, due to compatibility with the polyamide matrix resin, the impact modifier may not form uniform domains, and a large amount of domains having a size of 10 μm or more may occur. Thus, in some cases, the impact modifier, as well as the polyamide matrix resin, may only be present as a continuous phase and may not form domains, and thus, may not improve impact resistance. Further, a problem in which a die swelling phenomenon may occur seriously may be caused.

Thus, an exemplary embodiment may propose that after a masterbatch is prepared by first melt-mixing an impact modifier and electroconductive fillers, the masterbatch is blended and melt-mixed with a matrix resin.

When the masterbatch including the impact modifier and the electroconductive fillers is used, the electroconductive fillers included in the masterbatch may have a higher affinity to polyamide than to the impact modifier, and may thus move toward the polyamide matrix.

The behavior of such an electroconductive filler may be conceptually illustrated as in FIG. 3. As illustrated in FIG. 3, after an impact modifier such as a polyolefin elastomer (POE) and an electroconductive filler such as a carbon nanotube (CNT) are prepared as a masterbatch, for example, an impact modifier-electroconductive filler masterbatch is prepared, when a polyamide polymer having higher affinity to the impact modifier is used as a matrix resin, the carbon nanotube, the electroconductive filler present in the impact modifier, may migrate to the polyamide polymer having high affinity thereto.

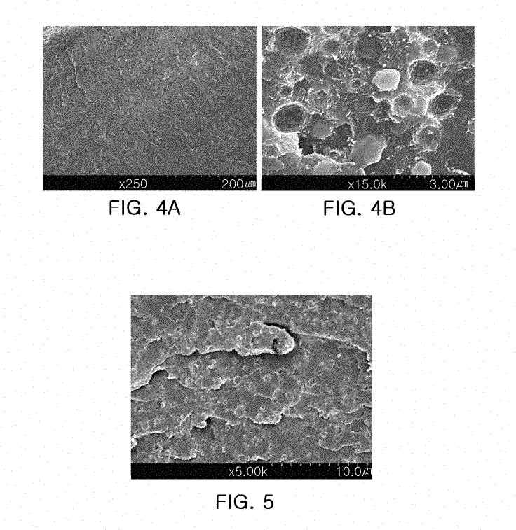

As a result, the electroconductive filler may be present in the matrix resin or at an interface between the matrix resin and the impact modifier to form networks with each other, and the impact modifier may be uniformly dispersed in the matrix while forming fine domains. For example, a resin composite having a morphology in which fine and uniform domains are formed as illustrated in FIG. 4A may be obtained.

The reason why the impact modifier forms a fine domain has not been clear, but when the electroconductive fillers such as CNTs or the like are impregnated in the impact modifier, a viscosity of the impact modifier may be increased, which may facilitate formation of domains in the matrix resin. In addition, the electroconductive fillers such as CNTs or the like may prevent domains from being re-agglomerated, by electroconductive fillers such as CNTs or the like present at an interface, during a migration process of the electroconductive filler toward a matrix having a relatively high affinity to the electroconductive filler. It is assumed that simultaneously therewith, the electroconductive fillers such as CNTs or the like, having moved to the polyamide matrix resin, increases the viscosity of the matrix resin, thereby increasing shear stress and thus reducing a domain size of the impact modifier. As a result, the morphology of the resin composite may also be stably formed.

On the other hand, differently from an exemplary embodiment in the present disclosure, if the polyamide matrix resin, the impact modifier and the electroconductive fillers are simultaneously melt-mixed, the polyamide matrix resin, the impact modifier and the electroconductive filler may be melt-mixed with each other due to affinity between the electroconductive filler and the polyamide matrix resin, but a function of miniaturizing the domain size of the impact modifier may not be carried out. In this case, impact modifier particles may coalesce with each other due to a compatibility problem between the impact modifier and the polyamide matrix resin, thereby significantly increasing a domain size, as illustrated in FIG. 11A. In this case, an effect of improving impact resistance may be significantly low.

Further, if polyamide matrix resin and the electroconductive fillers are melt-mixed to form the masterbatch and then the masterbatch is blended and melt-mixed with the impact modifier, the electroconductive fillers may be present in the polyamide matrix resin having high affinity as it is, and the impact modifier may not stably form domains due to a comparability problem between the polyamide matrix resin and the impact modifier. Furthermore, CNT may not be sufficiently dispersed to form agglomerates, resulting in a decrease in electrical conductivity.

Thus, in order to produce the resin composite according to an exemplary embodiment, a composite may be produced by melt-mixing a composition including a masterbatch containing an impact modifier and electroconductive fillers.

The production of the masterbatch including the impact modifier and the electroconductive fillers is not particularly limited, and may be performed via a general masterbatch production method, using a kneader, an extruder such as a single-screw extruder or a twin-screw extruder, or the like, used generally. For example, in the case of using a twin-screw extruder in the production of the masterbatch, an impact modifier may be fed into a main supply portion of the twin-screw extruder, and an electroconductive filler may be fed into a side supply portion thereof to then be subjected to melt-mixing.

Subsequently, a molten strand discharged from a die of the extruder may then be cooled in a cooling water bath to obtain a solidified strand, and a pelletized masterbatch may be obtained through a cutter. A shape of the masterbatch is not particularly limited, and may be, for example, spherical or chip-shaped.

As described above, the masterbatch may further include a compatibilizing agent. The masterbatch may be prepared by blending and melt-mixing the compatibilizing agent together with the impact modifier and the electroconductive filler provided in the impact modifier-electroconductive filler masterbatch. Thus, the dispersion of the electroconductive filler may be further improved in the polyamide matrix or at an interface between the polyamide matrix and the impact modifier.

In addition, the prepared masterbatch may be melt-mixed with a polyamide resin to prepare a secondary masterbatch. In the case in which the masterbatch does not include a compatibilizing agent, the compatibilizing agent may be included in preparing the secondary masterbatch. At this time, electroconductive fillers such as CNTs or the like may be further added to adjust a required content ratio as needed.

In the case of producing the secondary masterbatch as described above, the electroconductive filler may be added in a melt-mixing process, such that the impact modifier may be formed in a relatively fine particle size, and furthermore, the electroconductive fillers may be located in the polyamide matrix or at an interface between the polyamide matrix and the impact modifier.

As suggested in the exemplary embodiment, when the masterbatch of the impact modifier and the electroconductive fillers is blended melt-mixed with a polyamide matrix resin, a domain size of the impact modifier may be reduced, aggregation of the electroconductive fillers may also be suppressed, and dispersibility thereof may be improved. In the case of an exemplary embodiment, a polymer composite, in which the number of agglomerates of the electroconductive fillers, having a longest diameter of agglomerate particles, is 50 or less, in detail, 30 or less, or in further detail, is only 10 or less to provide excellent dispersibility, may be obtained.

The size and the number of agglomerates of the electroconductive fillers, such as CNTs or the like, may be measured from 50 SEM images at 250× magnification, having an area of 0.5 mm×0.35 mm, and the size and number of agglomerates of the electroconductive fillers such as CNTs may be measured. In detail, as described in the exemplary embodiment, five of the same Izod impact specimens (ASTM D256) may be broken in liquid nitrogen, and then, may be randomly imaged with a scanning electron microscope (SEM) at 250× magnification to obtain 10 images of each specimen. Subsequently, the size and the number of agglomerates of the electroconductive fillers, such as CNTs, may be measured from 50 SEM images each having an area of 0.5 mm×0.35 mm. The agglomerate size may be measured based on a longest diameter of agglomerate particles.

In the composition above, although the masterbatch of the impact modifier and the electroconductive filler is not particularly limited as long as it may be controlled according to electric conductivity and impact resistance required for the resin composite to be obtained, a content of the electroconductive filler included in the masterbatch may be 1 wt % to 50 wt % with respect to 100 wt % of the masterbatch. For example, the electroconductive filler may be included in the masterbatch, in a range of 5 wt % to 40 wt %, 5 wt % to 30 wt %, 5 wt % to 25 wt %, 10 wt % to 30 wt %, 10 wt % to 25 wt %, 10 wt % to 20 wt %, or the like, with respect to a weight of the masterbatch.

In addition, for example, when the masterbatch further includes a compatibilizing agent, the compatibilizing agent may be included in an amount of 0.5 wt % to 30 wt %.

On the other hand, in the case of the polyamide matrix resin and the masterbatch, 0.1 wt % to 50 wt % of the masterbatch may be included therein based on a total 100 wt %, as a sum of the polyamide matrix resin and the masterbatch. For example, the masterbatch may be included in a range of 1 wt % to 50 wt %, 1 wt % to 45 wt %, 5 wt % to 45 wt %, 5 wt % to 40 wt %, 5 wt % to 30 wt %, 5 wt % to 25 wt %, 10 wt % to 30 wt %, 10 wt % to 25 wt %, 15 wt % to 25 wt %, or the like.

The composition may further include an additive, which is generally added to a resin composition as required. A composition to be added to the composition of an exemplary embodiment is not particularly limited. For example, a reinforcing filler for reinforcement of strength, a dispersing agent for improvement of dispersibility of an electroconductive filler such as CNT or the like, a compatibilizing agent for improvement in compatibilization of a resin, an antioxidant, an ultraviolet stabilizer, or the like may be used. In addition, in consideration of physical properties required for the composite, and the like, other resins may be further included as required, as well as the polyamide matrix resin.

The reinforcing agent is not particularly limited as long as it is generally used in a resin composition, and examples thereof may include glass fiber, talc, calcium carbonate, clay, and the like.

The resin composite obtained according to an exemplary embodiment may include 1 wt % to 40 wt % of an impact modifier and 0.1 wt % to 20 wt % of CNT with respect to 100 wt %, a total weight of a polyamide matrix resin, an impact modifier and electroconductive fillers, and may include a residual polyamide matrix resin. For example, the resin composite may include 2 wt % to 20 wt % of the impact modifier, 0.5 wt % to 3 wt % of CNT, and a polyamide matrix resin as a remainder thereof.

The resin composite obtained according to the exemplary embodiment may have different results in measuring Izod impact strength, depending on contents of the impact modifier and the electroconductive fillers used when Izod impact strength is measured using Notched IZOD. Compared with a resin composite of the related art in which composition components are simultaneously added, the resin composite of the exemplary embodiment may result in impact resistance being improved to be as low as 10% and as much as 600%, in the case in which the contents of the impact modifier and the electroconductive filler are the same as those in the related art.

For example, the resin composite according to an exemplary embodiment may have notched Izod impact strength of 10 kgf/cm to 65 kgf/cm. In addition, the resin composite according to an exemplary embodiment may have electric resistance of 1.0×10¹ to 1.0×10⁹, in detail, 1.0×10¹ to 1.0×10⁶, while having impact strength as above.

### EXAMPLES

Hereinafter, exemplary embodiments will be described. However, the following exemplary embodiments are for illustrative purposes only and are not intended to limit the scope of the present invention.

### Example 1

POE (SKGC, Solumer 875L) was supplied as an impact modifier to a main feeder of a twin screw extruder having a total of 12 barrels, 40Φ, L/D=48, and multi-walled CNT (MWCNT) in which the number of walls was 7 to 10, purity was 84%, and an aspect ratio was 350 was supplied as an electroconductive filler to a side feeder, to then be blended and melt-mixed, thereby preparing a POE/MWCNT masterbatch.

Subsequently, using the same equipment as above, a polyamide 66 (PA66) matrix resin (Solvay, 24AE1K) and the POE/MWCNT masterbatch were melt-mixed to produce an injection molded article according to an ASTM standard. At this time, CNT may be additionally supplied as needed.

In this case, the contents of PA66, POE and MWCNT were adjusted to content ratios as illustrated in Table 1.

The molded article obtained as above was measured for tensile strength (ASTM D 638), flexural elastic modulus (ASTM D 790), impact strength (ASTM D 256), surface electrical resistance (JIS K7194) and CNT agglomerate sizes, and results thereof are illustrated in Table 2.

In measuring the CNT agglomerate size, five of the same Izod impact specimens (ASTM D256) were broken in liquid nitrogen and then randomly imaged with a scanning electron microscope (SEM) at 250× magnification to obtain 10 images of each specimen. Subsequently, the size and the number of CNT agglomerates were measured from 50 SEM images each having an area of 0.5 mm×0.35 mm, and the CNT agglomerate size was measured based on a longest diameter of agglomerate particles.

Further, a surface of the molded article was subjected to SEM imaging, and results thereof are provided in FIGS. 4A and 4B. FIG. 4A is an SEM image of 250× magnification, and FIG. 4B is an SEM image of 15,000× magnification.

### Example 2

POE (SKGC, Solumer 875L) and MA-g-POE (MA grafted POE(=MAPOE)) were supplied as an impact modifier to a main feeder of a twin screw extruder having a total of 12 barrels, 40Φ, L/D=48, and multi-walled CNT (MWCNT) in which the number of walls was 7 to 10, purity was 84%, and an aspect ratio was 350 was supplied as an electroconductive filler to a side feeder, then be melt-mixed, thereby preparing a (POE+MA-g-POE)/MWCNT masterbatch.

Subsequently, using the same extruder, a polyamide (PA66) matrix resin (Solvay, 24AE1K) and the (POE+MAPOE)/MWCNT masterbatch were melt-mixed to produce an injection molded article according to an ASTM standard.

In this case, the contents of PA66, POE, MAPOE and MWCNT were adjusted to content ratios as illustrated in Table 1.

The molded article obtained as above was subjected to the same measurement as in Embodiment 1, and results thereof are illustrated in Table 2. Further, a surface of the molded article was subjected to SEM imaging, and results thereof are provided in FIG. 5.

### Example 3

POE (SKGC, Solumer 875L) was supplied as an impact modifier to a main feeder of a twin screw extruder having a total of 12 barrels, 40Φ, L/D=48, and multi-walled CNT (MWCNT) in which the number of walls was 7 to 10, purity was 84%, and an aspect ratio was 350 was supplied as an electroconductive filler to a side feeder, to then be melt-mixed, thereby preparing a POE/MWCNT masterbatch.

Subsequently, using the same equipment as above, a polyamide 66 (PA66) matrix resin (Solvay, 24AE1K), the POE/MWCNT masterbatch and MAPOE were melt-mixed to produce an injection molded article according to an ASTM standard.

In this case, the contents of PA66, POE, MAPOE and MWCNT were adjusted to content ratios as illustrated in Table 1.

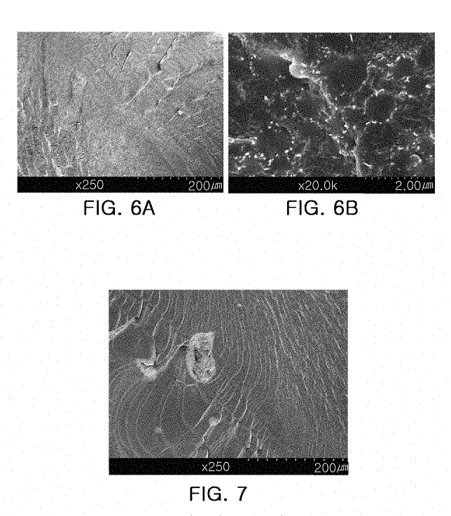

The molded article obtained as above was subjected to the same measurement as in Embodiment 1, and results thereof are illustrated in Table 2. Further, a surface of the molded article was subjected to SEM imaging, and results thereof are provided in FIGS. 6A and 6B. FIG. 6A is an SEM image of 250× magnification, and FIG. 6B is an SEM image of 20,000× magnification.

### Example 4

An injection molded article was produced in the same manner as in Embodiment 1, except that PA66, POE, MAPOE and MWCNT were adjusted to content ratios as illustrated in Table 1.

The molded article obtained as above was subjected to the same measurement as in Embodiment 1, and results thereof are illustrated in Table 2.

### Example 5

An injection molded article was produced in the same manner as in Embodiment 2, except that PA66, POE, MAPOE and MWCNT were adjusted to content ratios as illustrated in Table 1.

The molded article obtained as above was subjected to the same measurement as in Embodiment 1, and results thereof are illustrated in Table 2.

### Comparative Example 1

As illustrated in Table 1, 100 wt % of PA66 resin was prepared to produce an injection molded article.

The molded article obtained as above was subjected to the same measurement of physical properties as in Embodiment 1, and results thereof are illustrated in Table 3.

### Comparative Example 2

As illustrated in Table 1, 97 wt % of PA66 resin and 3 wt % of CNT, with respect to a total content of a blended resin composition, were directly melt-mixed to prepare an injection molded article.

The molded article obtained as above was subjected to the same measurement of physical properties as in Embodiment 1, and results thereof are illustrated in Table 3.

Further, a surface of the molded article was subjected to SEM imaging, and results thereof are provided in FIG. 7.

### Comparative Example 3

PA66, POE and CNT were simultaneously blended at content ratios as illustrated in Table 1, and were melt-mixing to produce an injection molded article.

The molded article obtained as above was subjected to the same measurement of physical properties as in Embodiment 1, and results thereof are illustrated in Table 3.

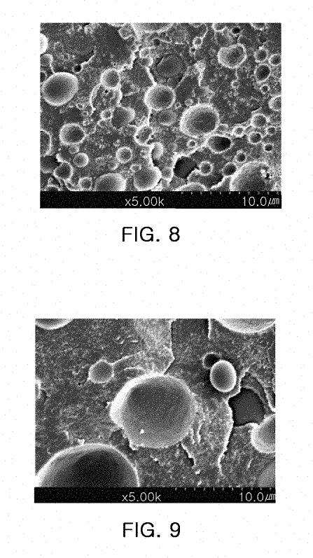

Further, a surface of the molded article was subjected to SEM imaging, and results thereof are provided in FIG. 8.

### Comparative Example 4

PA66, POE and CNT were used in contents as illustrated in Table 1, in which PA66 and CNT were blended, and then, POE was blended and melt-mixed therewith to prepare an injection molded article.

The molded article obtained as above was subjected to the same measurement of physical properties as in Embodiment 1, and results thereof are illustrated in Table 3.

Further, a surface of the molded article was subjected to SEM imaging, and results thereof are provided in FIG. 9.

### Comparative Example 5

PA66, POE, MAPOE and CNT were used in contents as illustrated in Table 1, in which PA66 and CNT were blended, and then, POE and MAPOE were blended and melt-mixed therewith to prepare an injection molded article.

The molded article obtained as above was subjected to the same measurement of physical properties as in Embodiment 1, and results thereof are illustrated in Table 3.

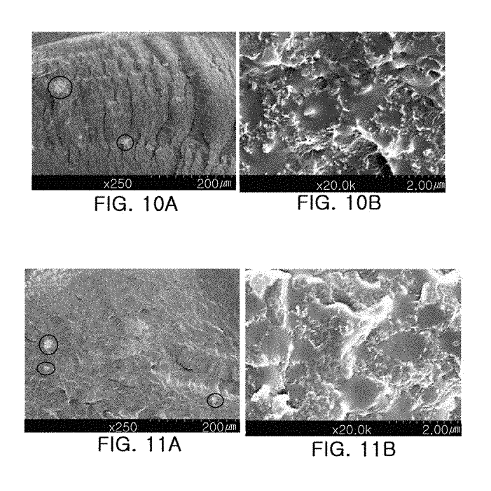

A surface of the molded article obtained above was subjected to SEM imaging, and results thereof are provided in FIGS. 10A and 10B. FIG. 10A is an SEM image of 250× magnification, and FIG. 10B is an SEM image of 20,000× magnification.

### Comparative Example 6

PA66, POE, MAPOE and MWCNT were simultaneously blended at content ratios as illustrated in Table 1, and were melt-mixing to produce an injection molded article.

The molded article obtained as above was subjected to the same measurement of physical properties as in Embodiment 1, and results thereof are illustrated in Table 3.

A surface of the molded article obtained above was subjected to SEM imaging, and results thereof are provided in FIGS. 11A and 11B. FIG. 11A is an SEM image of 250× magnification, and FIG. 11B is an SEM image of 20,000× magnification.

TABLE 1

| | Exemplary | | | | | Comparative | | | | | |
|---|---|---|---|---|---|---|---|---|---|---|---|
| | Embodiment | | | | | Example | | | | | |
| | 1 | 2 | 3 | 4 | 5 | 1 | 2 | 3 | 4 | 5 | 6 |
| PA66 (wt %) | 88.7 | 88.7 | 88.7 | 80 | 80 | 100 | 97 | 88.7 | 88.7 | 80 | 80 |
| POE (wt %) | 8.3 | 6.4 | 6.4 | 14.5 | 14.5 | 0 | 0 | 8.3 | 8.3 | 14.5 | 14.5 |
| MAPOE (wt %) | 0 | 1.9 | 1.9 | 3 | 3 | 0 | 0 | 0 | 0 | 3 | 3 |
| CNT (wt %) | 3 | 3 | 3 | 2.5 | 2.5 | 0 | 3 | 3 | 3 | 2.5 | 2.5 |

TABLE 2

| | | Unit | Embodiment 1 | Embodiment 2 | Embodiment 3 | Embodiment 4 | Embodiment 5 |
|---|---|---|---|---|---|---|---|
| Tensile | Stress | Kgf/cm² | 678.5 | 665.3 | 654.8 | 541.7 | 522.6 |
| Strength | (Yielding) | MPa | 66.5 | 65.2 | 64.2 | 53.1 | 51.2 |
| | Stress | Kgf/cm² | 678.4 | 659 | 646.5 | 529.6 | 516.2 |
| | (At the | MPa | 66.5 | 64.6 | 63.4 | 51.9 | 50.6 |
| | time of | | | | | | |
| | breakage) | | | | | | |
| | Elongation | % | 21.3 | 21.5 | 22.3 | 35.2 | 38.4 |
| | (At the | | | | | | |
| | time of | | | | | | |
| | breakage) | | | | | | |
| Curvature | Modulus | Kgf/cm² | 27564 | 26521 | 26839 | 22168 | 21226 |
| Elastic | | MPa | 2703.1 | 2601 | 2632 | 2174 | 2082 |
| Modulus | | | | | | | |
| Notched IZOD Impact | | kgfcm/cm | 6.2 | 11.2 | 14.5 | 16.7 | 16.3 |
| Strength | | | | | | | |
| Resistance (4 probe | | Ω/sq | 7.7 × 10² | 3.1 × 10⁴ | 2.3 × 10⁴ | 7.3 × 10³ | 7.0 × 10³ |
| method) | | | | | | | |
| Domain | Average | μm | 1.2 | 1.2 | 1.3 | 1.4 | 1.3 |
| Size | Standard | μm | 0.3 | 0.2 | 0.2 | 0.3 | 0.3 |
| | Deviation | | | | | | |

| | | | | | | |
|---|---|---|---|---|---|---|
| CNT agglomerate | Number | 9 | 12 | 14 | 8 | 9 |
| Longest Diameter of | | | | | | |
| 10 μm or more | | | | | | |

TABLE 3

| | | | Comparative | Comparative | Comparative | Comparative | Comparative | Comparative |
|---|---|---|---|---|---|---|---|---|
| | | Unit | Example 1 | Example 2 | Example 3 | Example 4 | Example 5 | Example 6 |
| Tensile | Stress | Kgf/cm² | 722.3 | 614.5 | 669.7 | 639.6 | 538.2 | 524.3 |
| Strength | (Yielding) | MPa | 70.8 | 60.3 | 65.7 | 62.7 | 52.8 | 51.4 |
| | Stress | Kgf/cm² | 691.5 | 614.5 | 668.1 | 634.3 | 529.6 | 516.8 |
| | (At the | MPa | 67.8 | 60.3 | 65.5 | 62.2 | 51.9 | 50.7 |
| | time of | | | | | | | |
| | breakage) | | | | | | | |
| | Elongation | % | 20.1 | 2.2 | 9.3 | 14.2 | 31.3 | 28.5 |
| | (At the | | | | | | | |
| | time of | | | | | | | |
| | breakage) | | | | | | | |
| Curvature | Modulus | Kgf/cm² | 27865 | 35452 | 26900 | 27145 | 22685 | 24330 |
| Elastic | | MPa | 2733 | 3477 | 2638 | 2662.0 | 2225 | 2386 |
| Modulus | | | | | | | | |
| Notched IZOD Impact | | kgfcm/cm | 4.1 | 4.5 | 3.4 | 3.5 | 10.4 | 8.6 |
| Strength | | | | | | | | |
| Resistance (4 probe | | Ω/sq | — | 1.7 × 10³ | 1.5 × 10³ | 4.9 × 10³ | 3.2 × 10⁶ | 3.5 × 10⁷ |
| method) | | | | | | | | |
| Domain | Average | μm | — | — | 6.2 | 5.3 | 1.5 | 1.4 |
| Size | Standard | μm | — | — | 1.5 | 1.2 | 0.5 | 0.4 |
| | Deviation | | | | | | | |

| | | | | | | | |
|---|---|---|---|---|---|---|---|
| CNT agglomerate | Number | — | 103 | 65 | 94 | 86 | 76 |
| Longest Diameter of | | | | | | | |
| 10 μm or more | | | | | | | |

Domain sizes illustrated in Table 2 and Table 3 were obtained as five of the same Izod impact specimens (ASTM D256) were broken in liquid nitrogen, and then, were randomly imaged with a scanning electron microscope (SEM) at 5 k (5000×) magnification to obtain 10 images of each specimen, and subsequently, the size and the number of domains were measured from 50 SEM images to calculated an average of the sizes. In this case, in the case in which the domain is not circular, a longest length was measured.

It can be seen from Table 2 that in the case of Embodiments 1 to 5 in which the masterbatch (MB) was produced using POE and/or MA-g-POE and CNT and then blended with the polyamide resin, impact strength of a molded article has been significantly improved.

However, in the case of Comparative Examples 3 and 4 in which MA-g-POE is not included without blending in form of a masterbatch, impact strength was not improved in a molded article. Thus, it can be seen that in order to improve impact resistance in the case in which an electroconductive filler is included in a polyamide resin, POE may be blended in the form of a CNT masterbatch, and in order to further increase impact strength, MA-g-POE may be included together therewith.

Further, in the molded articles of Comparative Example 5 and Comparative Example 6 in which POE was not blended in form of a CNT masterbatch while including MA-g-POE, an effect of improving impact strength was decreased as compared with the case of using the masterbatch. Thus, it can be seen that, even when POE and MA-g-POE are included, POE and CNT or POE and MA-g-POE and CNT should be produced as a masterbatch and then blended with polyamide to thus prepare a molded article.

On the other hand, it can be seen from FIG. 4 illustrating a surface of the molded article according to Embodiment 1 that no CNT agglomerate is found and CNT is selectively dispersed in PA66 and at an interface between PA66 and POE. However, in the case of FIG. 7 illustrating a surface of the molded article of Comparative Example 2 in which CNT was simply blended in PA66, agglomeration of CNTs was found.

In addition, it can be seen from FIG. 5 that a domain size of POE is relatively small size of 5 μm or less and POE is relatively uniformly dispersed. On the other hand, FIG. 8 illustrates an image of a surface of a molded article of Comparative Example 3 produced by simultaneously blending PA66, POE and CNT without a POE and CNT masterbatch. FIG. 9 illustrates an image of a surface of a molded article of Comparative Example 4 produced as PA66 and CNT are first blended and then blended with POE without a POE and CNT masterbatch. In comparing FIGS. 5, 8 and 9 with each other, it can be seen that a significantly reduced domain size is exhibited in the case of Embodiment 2.

In a manner similar thereto, in comparing FIG. 6 illustrating a surface of the molded article according to Embodiment 3 and FIGS. 10 and 11 illustrating surfaces of the molded articles according to Comparative Examples 6 and 7, it can be seen that the dispersion of CNT was significantly excellent in the case of the molded article according to Embodiment 3. In detail, no agglomerates of CNTs were found in FIG. 6, but agglomerates of CNTs as indicated by red circles were found in FIGS. 10 and 11.

As set forth above, according to an exemplary embodiment, an electroconductive filler may be selectively dispersed in a polymer matrix resin of polyamide or at an interface between a polymer matrix resin and an impact modifier, thereby securing excellent electrical conductivity.

In addition, according to another exemplary embodiment, an electroconductive filler may be uniformly dispersed in form of fine particles in a matrix of polyamide, to thus suppress an aggregation phenomenon of an electroconductive filler, thereby preventing a decrease in impact strength due to addition of an electroconductive filler.

While exemplary embodiments have been shown and described above, it will be apparent to those skilled in the art that modifications and variations could be made without departing from the scope of the present disclosure as defined by the appended claims.

What is claimed is:

1. An electroconductive resin composite, the composite comprising:
a polyamide resin matrix;
impact modifier domains dispersed in the matrix, the domains having an average particle size of 5 μm or less (excluding 0); and
electroconductive fillers dispersed in the matrix, wherein the number of agglomerates of the fillers in which the length of a longest diameter of an agglomerate is 10 μm or more is 50 or less, in 50 scanning electron microscope (SEM) images of an area of 0.5 mm×0.35 mm, captured at 250× magnification.

2. The composite of claim 1, wherein, based on the total weight of the fillers, 90% or more of the fillers are present in the matrix or at an interface between the matrix and the domains.

3. The composite of claim 1, wherein interfacial energy between the domains and the fillers is higher than interfacial energy between the matrix and the fillers.

4. The composite of claim 1, comprising 1 wt % to 40 wt % of the domains and 0.1 wt % to 20 wt % of the fillers based on the total weight of the composite.

5. The composite of claim 1, wherein the domains include copolymer of ethylene and octene or copolymer of ethylene and butane.

6. The composite of claim 1, further comprising a compatibilizing agent.

7. The composite of claim 5, wherein the compatibilizing agent is a graft copolymer grafted from maleic anhydride (MAH) or glycidyl methacrylate (GMA).

8. The composite of claim 6, comprising 1 wt % to 40 wt % of the domains, 0.5 wt % to 10 wt % of the compatibilizing agent and 0.1 wt % to 20 wt % of the fillers based on the total weight of the composite.

9. An electroconductive resin composition comprising:
a polyamide resin; and
a masterbatch including an impact modifier and electroconductive fillers,
wherein, with respect to the fillers, interfacial energy of the impact modifier is higher than interfacial energy of the polyamide resin.

10. The composition of claim 9, comprising 0.1 wt % to 50 wt % of the masterbatch based on the total weight of the composition, and wherein the masterbatch includes 1 wt % to 50 wt % of the fillers based on the total weight of the masterbatch.

11. The composition of claim 9, further comprising a compatibilizing agent.

12. The composition of claim 11, comprising 0.5 wt % to 10 wt % of the compatibilizing agent, 0.1 wt % to 50 wt % of the masterbatch based on the total weight of the composition, and wherein the masterbatch includes 1 wt % to 50 wt % of the fillers based on the total weight of the masterbatch.

13. The composition of claim 11, comprising 0.1 wt % to 50 wt % of the masterbatch based on the total weight of the composition, wherein the masterbatch includes 1 wt % to 50 wt % of the fillers and 0.5 wt % to 10 wt % of the compatibilizing agent based on the total weight of the masterbatch.

14. The composition of claim 11, wherein the compatibilizing agent is a copolymer grafted from maleic anhydride (MAH) or glycidyl methacrylate (GMA).

15. A method of producing an electroconductive resin composite, the method comprising:
mixing a materbatch including an impact modifier and electroconductive filler with a polyamide resin to prepare a electroconductive resin composition; and
melt molding the composition to prepare a composite including:
a resin matrix including the polyamide resin;
impact modifier domains including the impact modifier, the domains being dispersed in the matrix and having an average particle size of 5 μm or less; and
conductive fillers dispersed in the matrix, wherein the number of agglomerates of the fillers in which the length of a longest diameter of an agglomerate is 10 μm or more is 50 or less, in 50 scanning electron microscope (SEM) images of an area of 0.5 mm×0.35 mm, captured at 250× magnification.

16. The method of claim 15, further comprising:
melt-mixing the impact modifier and the fillers to prepare the masterbatch.

17. The method of claim 15, further comprising:
melt-mixing the impact modifier, the fillers and a polyamide resin to prepare a secondary masterbatch.

18. The method of claim 15, wherein the composition further comprises a compatibilizing agent.

19. The method of claim 18, wherein the compatibilizing agent is a copolymer grafted from maleic anhydride (MAH) or glycidyl methacrylate (GMA).
